(19) United States
(12) Patent Application Publication
(10) Pub. No.: US 2017/0019301 A1
(43) Pub. Date: Jan. 19, 2017

(54) MANAGEMENT METHOD, INFORMATION PROCESSING DEVICE, AND STORAGE MEDIUM

(71) Applicant: FUJITSU LIMITED, Kawasaki-shi (JP)

(72) Inventors: DAISUKE HOSHI, Kawasaki (JP); TSUYOSHI OKUMURA, Kawasaki (JP); ATSUSHI NAGASE, Kawasaki (JP); KENICHI TAKAYANAGI, Kawasaki (JP); Junichi KAWANO, Kawasaki (JP); Katsuyuki Yanaka, Kawasaki (JP)

(73) Assignee: FUJITSU LIMITED, Kawasaki-shi (JP)

(21) Appl. No.: 15/208,657

(22) Filed: Jul. 13, 2016

(30) Foreign Application Priority Data
Jul. 15, 2015 (JP) 2015-141662

(51) Int. Cl. H04L 12/24

(52) U.S. Cl. CPC H04L 41/0873; H04L 41/082; H04L 41/0859; H04L 41/12

(57) ABSTRACT

A management method executed by a processor included in an information processing device coupled to a network that includes a plurality of devices, the plurality of devices including a target device in which a control program is to be updated, the management method includes extracting one or more devices from the plurality of devices by determining whether each of the plurality of devices belongs to a predetermined range within the network; determining, for each of the extracted one or more devices, whether a combination of the extracted device with the control program after updating has a problem; and updating the control program for the target device when it is determined that the combination does not have a problem.

### CROSS-REFERENCE TO RELATED APPLICATION

This application is based upon and claims the benefit of priority of the prior Japanese Patent Application No. 2015-141662, filed on Jul. 15, 2015, the entire contents of which are incorporated herein by reference.

### FIELD

The embodiment discussed herein is related to a management method, an information processing device, and a storage medium.

### BACKGROUND

In data centers and the like, an information processing system is built by combining multiple devices such as a server device, a network device, and a storage device. If firmware (FW) is to be updated in a certain device included in the information processing system, an administrator of the information processing system specifies, for a managing device, the target device in which the FW is to be updated and a version number of the FW.

Then, the managing device acquires type information from the target device, acquires an FW file based on the type information and the version number of the FW from an FW distribution medium for distribution of the updated FW, and applies the FW to the target device.

There is a related technique for updating a control program for a printer and thereby inhibiting a problem from occurring due to a version mismatch caused by the update of the control program to a new version if it is determined that the printer driver of the new version and the control program are compatible.

There is a related technique for enabling a device control program to be updated during a system operation by determining whether or not the device control program to be updated is applicable based on compatibility information related to a combination of a update control program for controlling the update of the device control program, a diagnosis program, and a system board.

There is a related technique for inhibiting an operational failure in advance by crosschecking latest version information stored in an auxiliary storage device with related version information within a module and checking whether or not a version of a module for executing loading is appropriate for relationships with another module and hardware. As related techniques, Japanese Laid-open Patent Publication No. 2001-27940, Japanese Laid-open Patent Publication No. 2006-146709, Japanese Laid-open Patent Publication No. 4-177426, and the like are disclosed.

When the FW of a certain device within the information processing device is updated, an operational failure may occur depending on combinations of the FW with FW of other devices coupled to the certain device. Thus, when the FW is to be updated, the managing device detects all the devices coupled to the certain device to be updated and confirms whether or not an operational failure occurs between the FW of all the coupled devices and the FW to be updated and it takes time to execute the confirmation. It is, therefore, desirable to reduce a time for executing the confirmation on the combinations of the FW to be updated with the FW of the other coupled devices.

### SUMMARY

According to an aspect of the invention, a management method executed by a processor included in an information processing device coupled to a network that includes a plurality of devices, the plurality of devices including a target device in which a control program is to be updated, the management method includes extracting one or more devices from the plurality of devices by determining whether each of the plurality of devices belongs to a predetermined range within the network; determining, for each of the extracted one or more devices, whether a combination of the extracted device with the control program after updating has a problem; and updating the control program for the target device when it is determined that the combination does not have a problem.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing system according to an embodiment;

FIG. 2 is a diagram describing FW update by a managing device;

FIG. 3 is a diagram illustrating a functional configuration of an FW updating section;

FIG. 4 is a diagram illustrating an example of device information;

FIG. 5 is a diagram illustrating range terminal determination requirements;

FIG. 6 is a diagram illustrating an example of connection information;

FIG. 7 is a diagram illustrating an example of contained version number information;

FIG. 8 is a diagram illustrating an example of comparison information;

FIG. 9 is a diagram illustrating an example of verification information;

FIG. 10 is a diagram illustrating parts that are to be compared and are included in the verification information illustrated in FIG. 9 and the comparison information illustrated in FIG. 8;

FIG. 11 is a diagram illustrating the comparison information to which verification results are added;

FIG. 12 is a diagram illustrating the comparison information after deletion;

FIG. 13 is a diagram illustrating an example of determination results;

FIG. 14 is a flowchart of an FW update process by the FW updating section;

FIG. 15 is a flowchart of a process by a connection configuration detector;

FIG. 16 is a flowchart of a connection destination detection process;

FIG. 17 is a flowchart of a process by a determining section;

FIG. 18 is a flowchart of a process of generating the comparison information;

FIG. 19 is a flowchart of a process of comparing the verification information with the comparison information;

FIG. 20 is a flowchart of a process of deleting an entry including a verification result that indicates not acceptable;

FIG. 21 is a flowchart of a process of determining the optimal version; and

FIG. 22 is a diagram illustrating a hardware configuration of a computer configured to execute a management program according to the embodiment.

### DESCRIPTION OF EMBODIMENT

Hereinafter, an embodiment of a managing device, a management method, and a management program is described with reference to the accompanying drawings. The embodiment does not limit techniques disclosed herein.

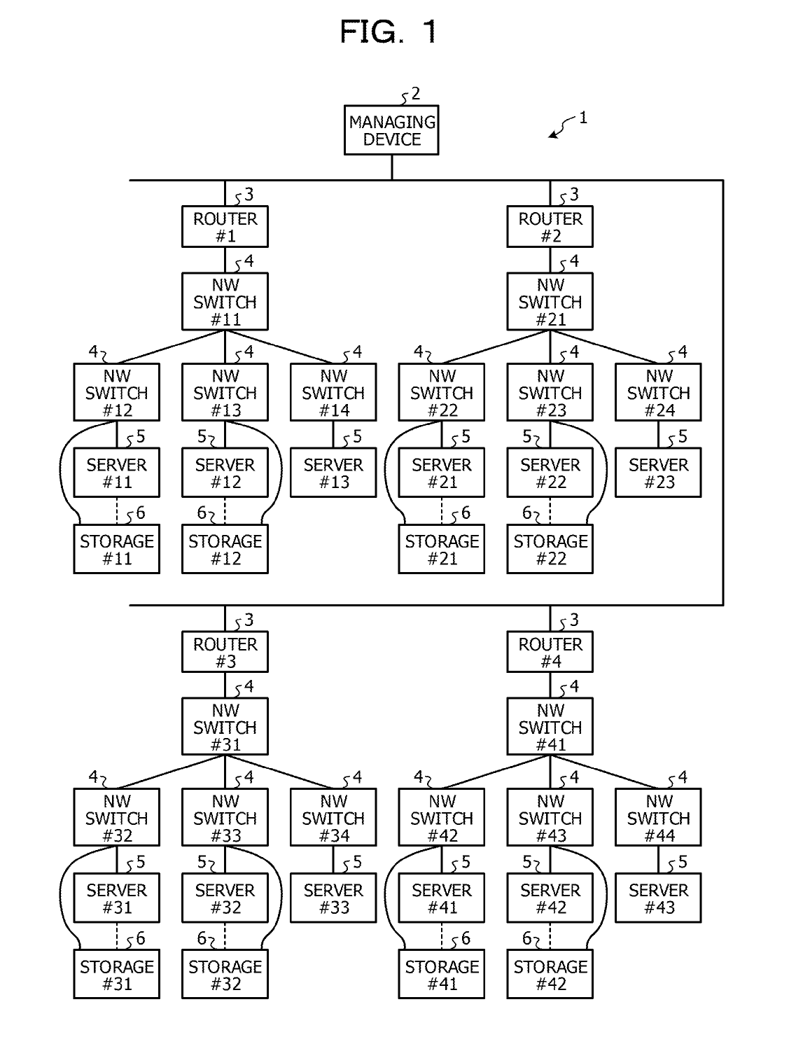

First, a configuration of an information processing system according to the embodiment is described. FIG. 1 is a diagram illustrating the configuration of the information processing system according to the embodiment. As illustrated in FIG. 1, the information processing system 1 according to the embodiment includes a managing device 2 and four routers 3 indicated by routers #1 to #4. The information processing system 1 includes sixteen NW switches 4 indicated by NW switches #11 to #14, NW switches #21 to #24, NW switches #31 to #34, and NW switches #41 to #44.

The information processing system 1 includes twelve servers 5 indicated by servers #11 to #13, servers #21 to #23, servers #31 to #33, and servers #41 to #43. The information processing system 1 includes eight storages 6 indicated by storage #11, storage #12, storage #21, storage #22, storage #31, storage #32, storage #41, and storage #42.

The managing device 2 is configured to manage the information processing system 1. The managing device 2 updates firmware (FW) of the devices that form the information processing system 1, for example. The routers 3 are devices configured to relay data to be transferred between different networks. The NW switches 4 are devices that are each configured to relay data in a single network sectioned by each of the routers 3. The servers 5 are devices configured to execute information processing. Each of the servers 5 communicates with the NW switches 4, the other servers 5 coupled through the routers 3, servers included in another information processing system, and the like. The storages 6 are devices configured to store data to be used by the servers 5.

Fiber channels (FCs) are provided between the servers 5 and the storages 6 so as to connect the servers 5 to the storages 6. Other connections between the devices are established by a local area network (LAN). In FIG. 1, the connections by the FCs are indicated by dotted lines, while the connections by the LAN are indicated by solid lines.

In FIG. 1, the information processing system 1 includes the four routers 3 and the devices coupled to the networks sectioned by the routers 3. The information processing system 1, however, may include five or more routers 3. In each of the networks sectioned by the routers 3, a larger number of devices may be coupled.

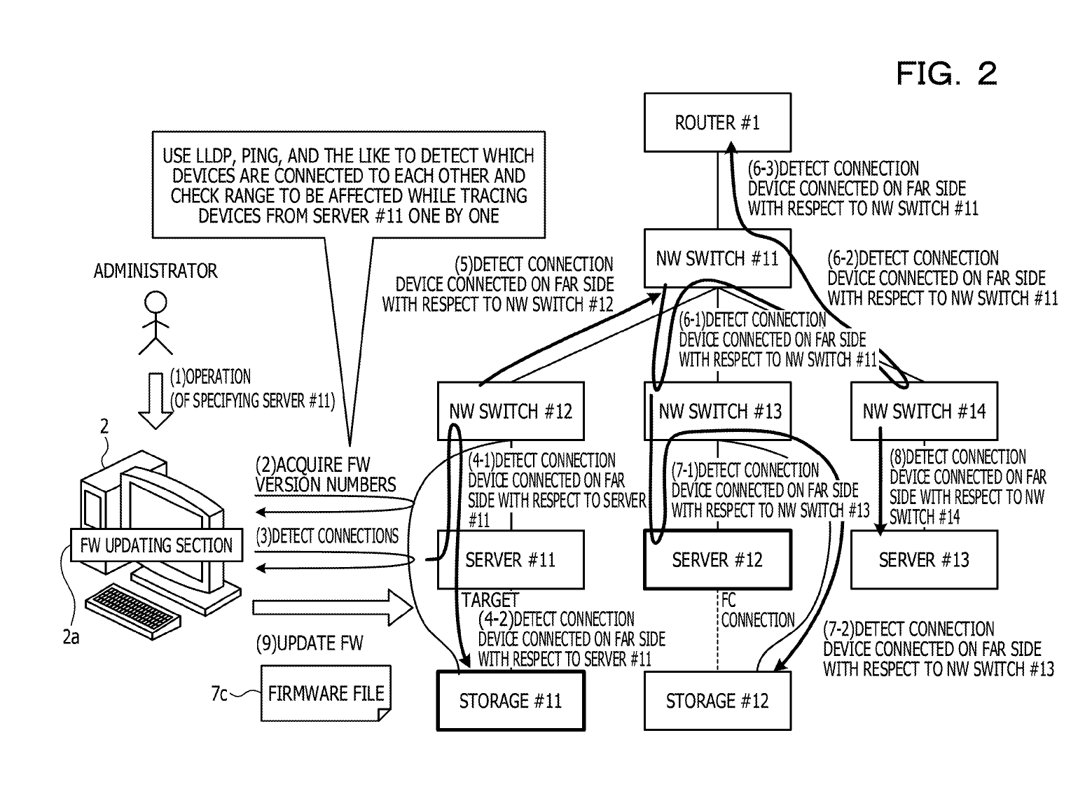

Next, FW update by the managing device 2 is described. FIG. 2 is a diagram describing the FW update by the managing device 2. As illustrated in FIG. 2, an administrator of the information processing system 1 operates the managing device 2 and specifies the server #11 as a target in which the FW is to be updated (1). The managing device 2 includes an FW updating section 2a configured to update the FW. The FW updating section 2a is specified the server #11 in which the FW is to be updated.

Then, the FW updating section 2a acquires version numbers of the FW of devices coupled to the server #11 in order to check the compatibility between versions of the FW of the devices coupled to the server #11 and a version to which the FW is to be updated (2). In order to acquire the version numbers of the FW of the devices coupled to the server #11, the FW updating section 2a detects the devices coupled to the server #11 (3). The FW updating section 2a uses the Link Layer Discovery Protocol (LLDP), a PING, and the like to detect which devices are coupled to each other.

Then, the FW updating section 2a checks a range to be affected by the FW update while tracing devices one by one from the server #11. The range to be affected is within the same network in the network layer (layer 3).

Specifically, the FW updating section 2a detects the NW switch #12 and the storage #11 as the devices coupled to and located on the far side with respect to the server #11 (4-1) (4-2). Next, the FW updating section 2a detects the NW switch #11 as a device coupled to and located on the far side with respect to the NW switch #12 (5). Then, the FW updating section 2a detects the NW switch #13, the NW switch #14, and the router #1 as devices coupled to and located on the far side with respect to the NW switch #11 (6-1) (6-2) (6-3). Then, the FW updating section 2a detects the server #12 and the storage #12 as devices coupled to and located on the far side with respect to the NW switch #13 (7-1) (7-2) and detects the server #13 as a device coupled to and located on the far side with respect to the NW switch #14 (8).

As illustrated in FIG. 1, the router #2 and the like are coupled to and located on the far side with respect to the router #1. The devices coupled to and located on the far side with respect to the router #1, however, belong to networks different from the network including the router #1 in the network layer. Thus, the FW updating section 2a does not trace the devices coupled to and located on the far side with respect to the router #1.

Then, the FW updating section 2a acquires version numbers of the FW of the detected devices that are the NW switch #12, the storage #11, the NW switch #11, the NW switch #13, the NW switch #14, the router #1, the server #12, the storage #12, and the server #13.

Then, the FW updating section 2a checks the compatibility between multiple versions of the FW to be updated and the versions of the FW of which the version numbers were acquired and selects a version with high compatibility from among the multiple versions of the FW to be updated. The version with the high compatibility is a version that does not cause an operational failure and the like to occur due to combinations of the selected version with the versions of the FW of which the version numbers were acquired. Then, the FW updating section 2a uses a firmware file 7c storing the selected FW to update the FW of the server #11 (9).

In this manner, the FW updating section 2a limits, to a range within the same network in the network layer, a range of the coupled devices of which the compatibility with the FW to be updated is to be checked, and thus a time for checking the compatibility may be reduced.

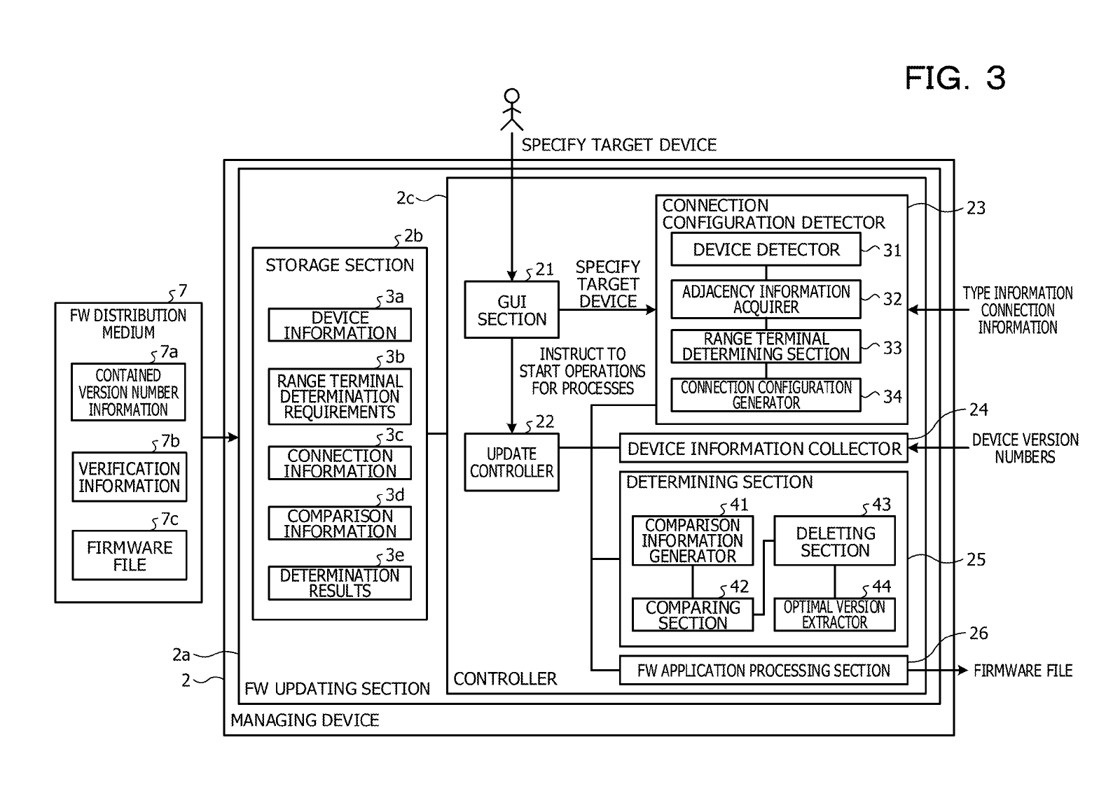

Next, a functional configuration of the FW updating section 2a is described. FIG. 3 is a diagram illustrating the functional configuration of the FW updating section 2a. As illustrated in FIG. 3, the FW updating section 2a includes a storage section 2b and a controller 2c. The FW updating section 2a reads data from an FW distribution medium 7.

The storage section 2b stores data to be used for processes to be executed by the FW updating section 2a. The storage section 2b stores device information 3a, range terminal determination requirements 3b, connection information 3c, comparison information 3d, and determination results 3e.

The FW distribution medium 7 is used to distribute the updated FW and information on the updated FW. The FW distribution medium 7 is, for example, a DVD. The FW distribution medium 7 stores contained version number information 7a, verification information 7b, and the firmware file 7c. The data stored in the FW distribution medium 7 is read into the storage section 2b and used.

The controller 2c uses the data stored in the storage section 2b to update the FW. The controller 2c includes a graphical user interface (GUI) section 21, an update controller 22, a connection configuration detector 23, a device information collector 24, a determining section 25, and an FW application processing section 26.

The GUI section 21 is specified a target device in which the FW is to be updated, while the administrator specifies the target device. Then, the GUI section 21 notifies the connection configuration detector 23 of the specified target device and instructs the update controller 22 to start an update operation.

The update controller 22 sequentially calls the connection configuration detector 23, the device information collector 24, the determining section 25, and the FW application processing section 26 and controls a process of updating the FW.

The connection configuration detector 23 detects, within the same network in the network layer, devices coupled to the target device notified by the GUI section 21. Then, the connection configuration detector 23 generates information on the detected devices. The connection configuration detector 23 includes a device detector 31, an adjacency information acquirer 32, a range terminal determining section 33, and a connection configuration generator 34.

The device detector 31 detects devices located adjacent to a focused device. The focused device is a device traced as an adjacent device while the target device notified by the GUI section 21 is used as an initial device. The device detector 31 uses the LLDP, the PING, and the like to detect the adjacent devices.

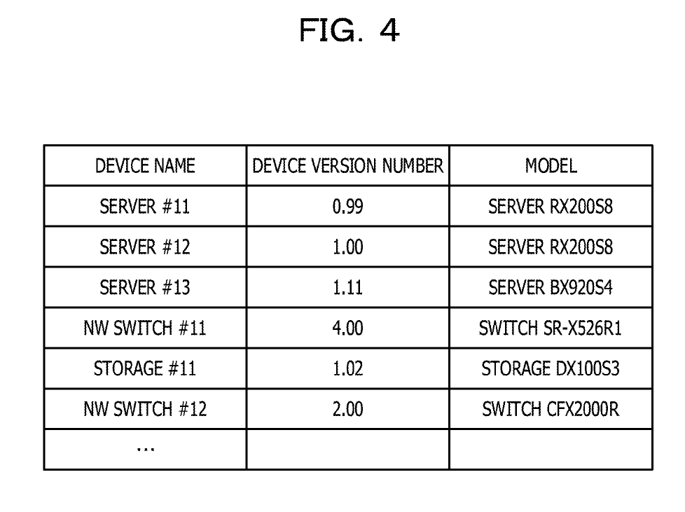

The adjacency information acquirer 32 acquires type information of the adjacent devices detected by the device detector 31 and records the acquired type information in the device information 3a. FIG. 4 is a diagram illustrating an example of the device information 3a. As illustrated in FIG. 4, the device information 3a is information in which a device name, a device version number, and a model are associated with each other for each of devices.

The device names are the names of the devices. The device version numbers are the version numbers of the FW installed in the devices. The models are type information of the devices. For example, a version number of the FW installed in the server #12 is 1.00. Type information of the server #12 is server RX200S8.

The device version numbers are recorded by the device information collector 24. Information of the target device in which the FW is to be updated is recorded by the connection configuration detector 23 in the device information 3a. In FIG. 4, information on the device whose name is server #11 is the information of the target device.

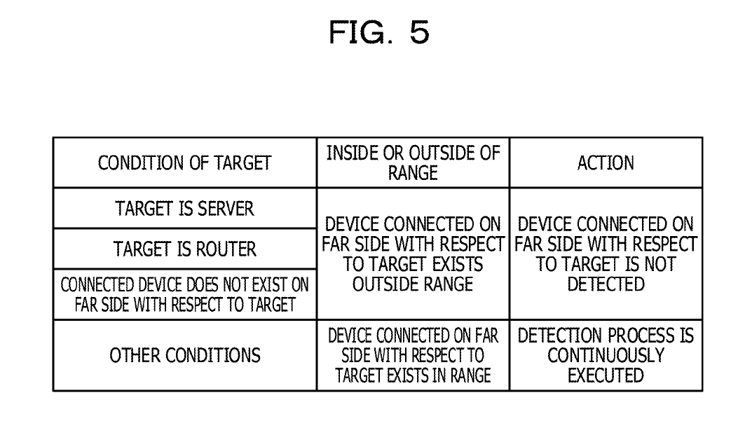

The range terminal determining device 33 uses the range terminal determination requirements 3b to determine, for the adjacent devices detected by the device detector 31, whether or not the tracing reaches a boundary of the range in which the coupled devices are traced. FIG. 5 is a diagram illustrating the range terminal determination requirements 3b. As illustrated in FIG. 5, the range terminal determination requirements 3b are information in which a condition of a target, the inside or outside of the range, and an action are associated with each other in each entry.

The condition of the target indicates a condition of each adjacent device. In each entry, the condition of the target is any of information indicating whether an adjacent device is a server 5 or a router 3, information indicating that a coupled device does not exist on the far side with respect to the adjacent device, and other conditions. The inside or outside of the range indicates whether a device coupled to and located on the far side with respect to the target device is coupled in or out of the range. The action indicates whether or not the connection configuration detector 23 continues to execute the detection process on a device coupled to and located on the far side with respect to the target device. For example, if the target device is a server 5, the device coupled to and located on the far side with respect to the target device is coupled out of the range and the connection configuration detector 23 does not detect the device coupled to and located on the far side with respect to the target device.

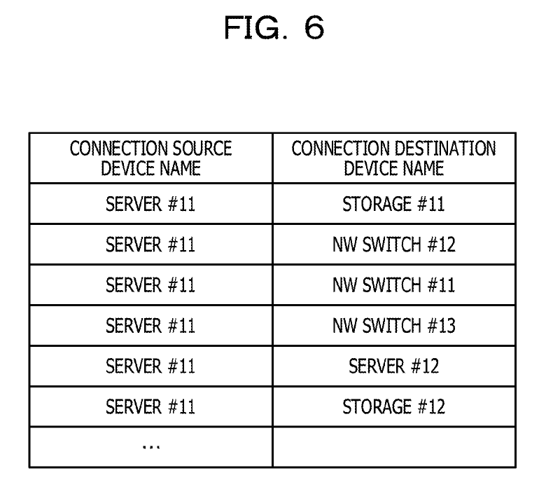

The connection configuration generator 34 generates, as the connection information 3c, information of the coupled devices detected in the range to be detected. FIG. 6 is a diagram illustrating an example of the connection information 3c. As illustrated in FIG. 6, the connection information 3c is information in which a connection source device name is associated with connection destination device names.

The connection source device name is the name of the device in which the FW is to be updated. In the example illustrated in FIG. 6, the connection source device name is the server #11. The connection destination device names are the names of the devices of which the compatibility of the FW is to be checked and that are coupled to the device in which the FW is to be updated. In FIG. 6, whether or not a problem occurs due to the FW of the storages #11 and #12, the NW switches #11 to #13, and the server #12 is checked.

The device information collector 24 acquires version numbers of the FW from the devices registered in the device information 3a. Then, the device information collector 24 records the acquired version numbers as device version numbers in the device information 3a.

The determining section 25 checks the compatibility between the multiple versions of the FW to be updated and versions of the FW of the devices registered in the connection information 3c. Then, the determining section 25 selects a single version to which the FW is to be updated from among the multiple versions of the FW to be updated. The determining section 25 includes a comparison information generator 41, a comparing section 42, a deleting section 43, and an optimal version extractor 44.

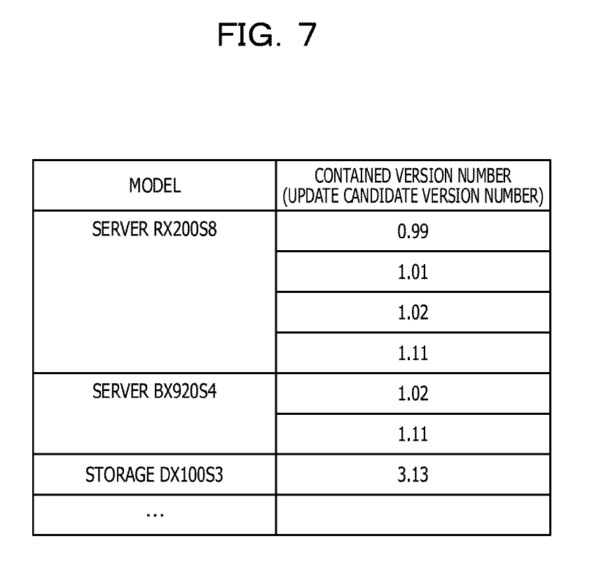

The comparison information generator 41 uses the device information 3a illustrated in FIG. 4, the connection information 3c illustrated in FIG. 6, and the contained version number information 7a illustrated in FIG. 7 to generate the comparison information 3d that is used to compare a version number of the FW of the connection source device with version numbers of the FW of the connection destination devices.

FIG. 7 is a diagram illustrating an example of the contained version number information 7a. As illustrated in FIG. 7, the contained version number information 7a is information in which models are associated with contained version numbers. The models are type information of devices. The contained version numbers are version numbers of the FW contained in the FW distribution medium 7. The contained version numbers are the numbers of candidate versions to which the FW is to be updated. Multiple candidate versions to which the FW is to be updated may exist for a single model. For example, regarding a server RX200S8, four versions whose numbers are 0.99, 1.01, 1.02, and 1.11 are candidate versions to which the FW is to be updated.

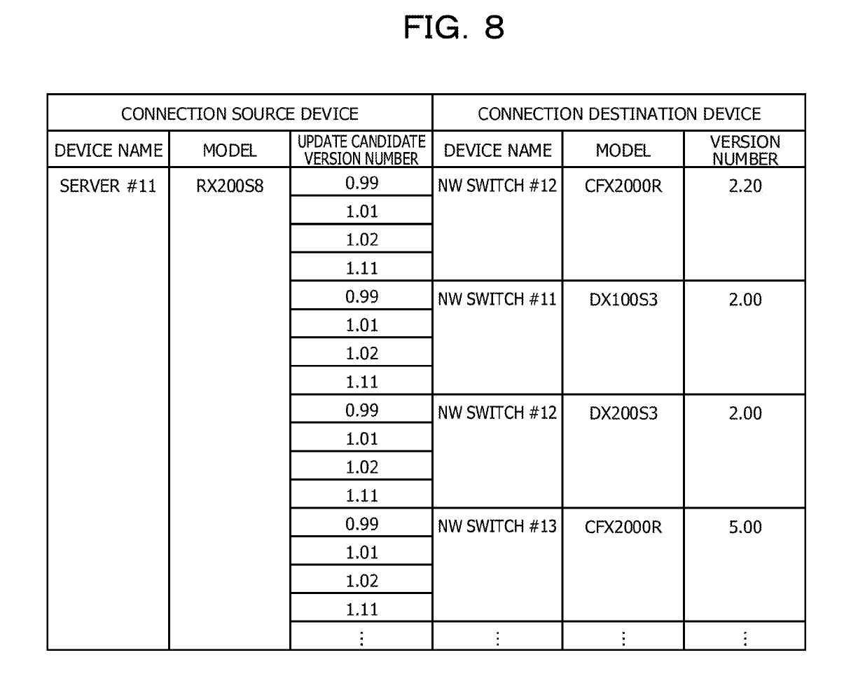

FIG. 8 is a diagram illustrating an example of the comparison information 3d. As illustrated in FIG. 8, the comparison information 3d is information in which information of the connection source device is associated with information of the connection destination devices for comparison of version numbers. The information of the connection source device includes a device name, a model, and update candidate version numbers. The device name is the name of the device in which the FW is to be updated. The model is type information of the device in which the FW is to be updated. The device name is the same in all entries and the model is the same in all the entries. In FIG. 8, each of the entries indicates a combination of an update candidate version number with a connection destination device.

The update candidate version numbers indicate version numbers of the FW contained in the FW distribution medium 7. The update candidate version numbers are repeated for the number of the connection destination devices. The device name is based on the name of the connection source device recorded in the connection information 3c illustrated in FIG. 6. The model is based on the model recorded in the device information 3a illustrated in FIG. 4. The update candidate version numbers are based on the contained version numbers illustrated in FIG. 7.

Information of the connection destination devices includes device names, models, and version numbers. The device names are the names of the devices of which the compatibility with the FW to be updated is to be checked, while the models are the models of which the compatibility with the FW to be updated is to be checked. The version numbers are the version numbers of the FW installed in the devices of which the compatibility with the FW to be updated is to be checked. The device names are based on the connection destination device names recorded in the connection information 3c illustrated in FIG. 6. The models are based on the models recorded in the device information 3a illustrated in FIG. 4. The version numbers are based on the device version numbers recorded in the device information 3a illustrated in FIG. 4. By the comparison information 3d, the version numbers of the FW installed in the connection destination devices are associated with the update candidate version numbers.

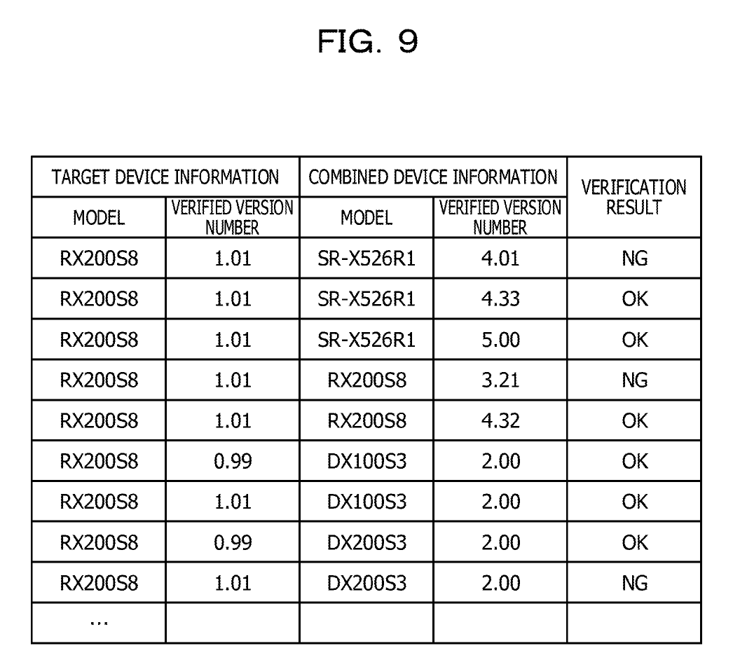

The comparing section 42 uses the verification information 7b illustrated in FIG. 9 to check combinations of the update candidate versions with the versions of the FW installed in the connection destination devices. Then, the comparing section 42 adds the results of the checking as verification results to the comparison information 3d. FIG. 9 is a diagram illustrating an example of the verification information 7b. As illustrated in FIG. 9, the verification information 7b is information in which target device information, combined device information, and a verification result are associated with each other for each of combinations of version numbers of the FW of device models.

The target device information is information of the target device for which combinations of version numbers of the FW are verified and indicates the model and the verified version numbers. The combined device information is information of devices for which the combinations of the target device with version numbers are verified and indicates the models and the verified version numbers. If a combination does not have a problem as a result of verification, a verification result indicates “acceptable”. On the other hand, if the combination has a problem as a result of the verification, the verification result indicates “not acceptable”.

For example, a combination of a model RX200S8 and the FW of a version number 1.01 with a model SR-X526R1 and the FW of a version number 4.01 has a problem, while a combination of the model RX200S8 and the FW of the version number 1.01 with the model SR-X526R1 and the FW of a version number 4.33 does not have a problem.

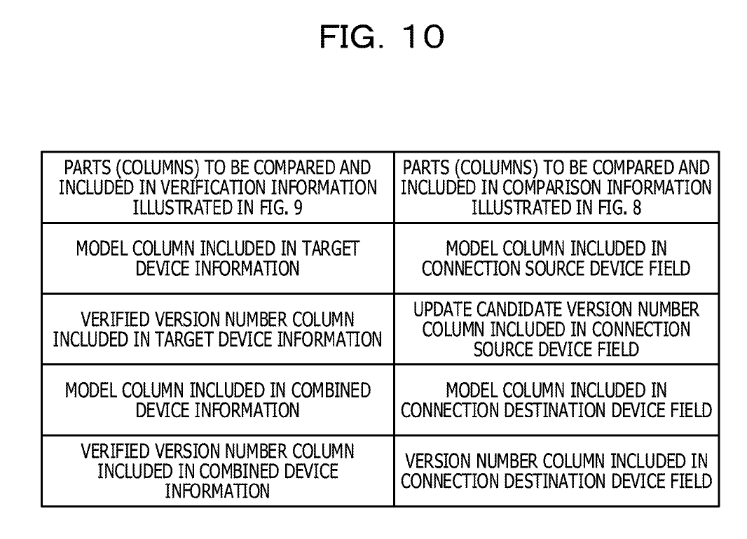

FIG. 10 is a diagram illustrating parts that are to be compared and are included in the verification information 7b illustrated in FIG. 9 and parts that are to be compared and are included in the comparison information 3d illustrated in FIG. 8. The comparing section 42 compares, based on the parts illustrated in FIG. 10 and to be compared, the parts included in the verification information 7b with the parts included in the comparison information 3d, extracts verification results from the verification information 7b, and adds the extracted verification results to the comparison information 3d. For example, the comparing section 42 compares a model column included in the target device information included in the verification information 7b with a model column included in a connection source device field included in the comparison information 3d.

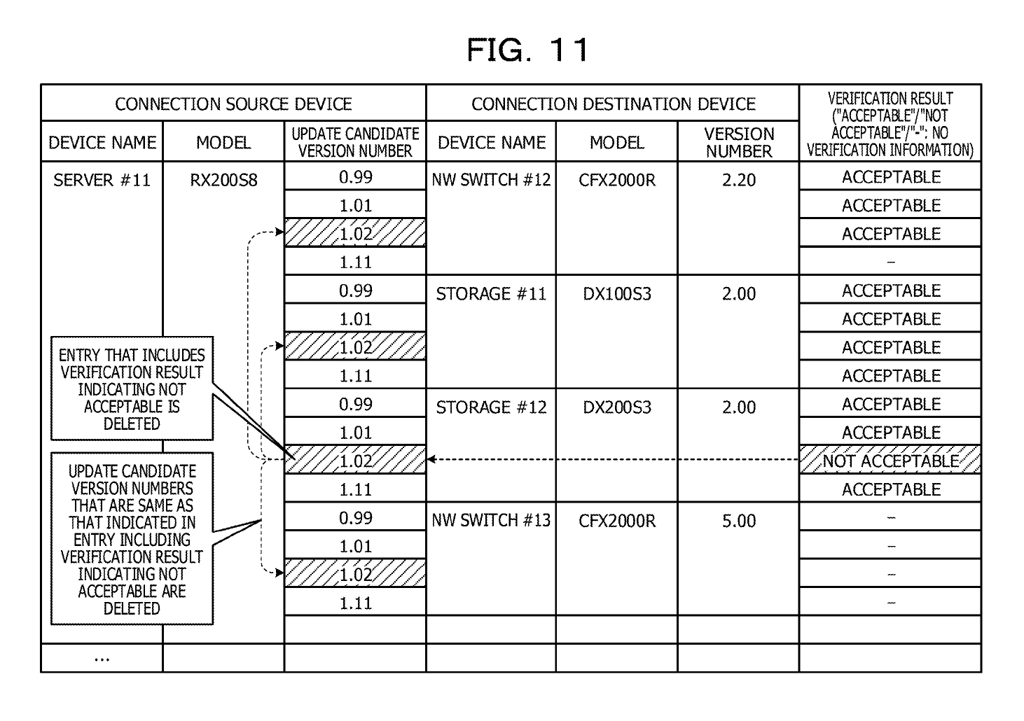

FIG. 11 is a diagram illustrating the comparison information 3d to which the verification results were added. For example, the FW with an update candidate version number 1.02 has high compatibility with the FW of the NW switch #12 and storage #11, but has low compatibility with the FW of the storage #12. In FIG. 11, if a combination of version numbers is not recorded in the verification information 7b, a result of verifying the combination indicates neither “acceptable” nor “not acceptable” and indicates no verification information or indicates “−”.

The deleting section 43 deletes, from the comparison information 3d illustrated in FIG. 11, an update candidate version number associated with at least one verification result indicating not acceptable. For example, in FIG. 11, a combination of the update candidate version number 1.02 with the FW of the storage #12 has a problem. In this case, the deleting section 43 deletes, from the comparison information 3d, all entries that include the update candidate version number 1.02.

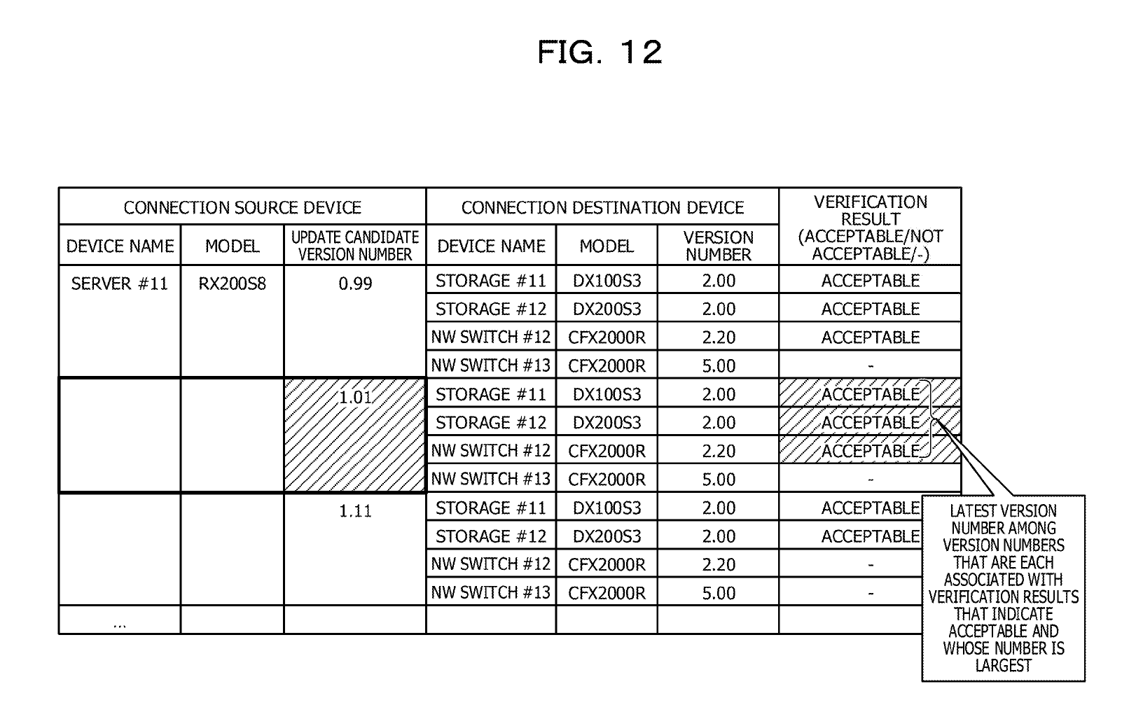

FIG. 12 is a diagram illustrating the comparison information 3d after the deletion. In FIG. 12, results of verifying combinations of update candidate version numbers with the connection destination devices are organized for each of the update candidate version numbers. As illustrated in FIG. 12, information on the update candidate version number 1.02 is deleted.

The optimal version extractor 44 extracts, from update candidate version numbers, an update candidate version number associated with connection destination devices associated with verification results that indicate acceptable and whose number is the largest. Then, the optimal version extractor 44 determines the extracted update candidate version number as a version to which the FW is to be updated. If the number of update candidate version numbers that are each associated with connection destination devices associated with verification results that indicate acceptable and whose number is the largest is two or more, the optimal version extractor 44 extracts the latest update candidate version number from the update candidate version numbers.

If the number of verification results that indicate no verification information is larger than the number of verification results that indicate acceptable, the optimal version extractor 44 determines that the optimal version does not exist. The reason for the determination is that if the number of verification results indicating no verification information is larger than the number of verification results indicating acceptable, the verification is not sufficient and a risk of the update is high. In FIG. 12, the number of verification results that are associated with the update candidate version number 1.01 and indicate acceptable is 3 and the largest, the update candidate version number 1.01 is newer than an update candidate version number 0.99 associated with verification results that indicate acceptable and whose number is 3 and the largest. Thus, the optimal version extractor 44 determines the update candidate version number 1.01 as the version to which the FW is to be updated.

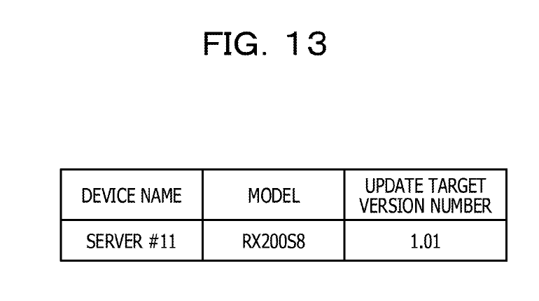

The determination results 3e are information in which the results of the extraction by the optimal version extractor 44 are recorded. FIG. 13 is a diagram illustrating an example of the determination results 3e. As illustrated in FIG. 13, the determination results 3e are information in which the device name, the model, and the update target version number are associated with each other. The update target version number is the version number of the FW that is determined by the determining section 25 as the version to which the FW is to be updated. FIG. 13 indicates that the model of the server #11 is RX200S8 and the update target version number is 1.01.

The FW application processing section 26 updates the FW of the target device based on the determination results 3e by applying the firmware file 7c contained in the FW distribution medium 7 to the target device.

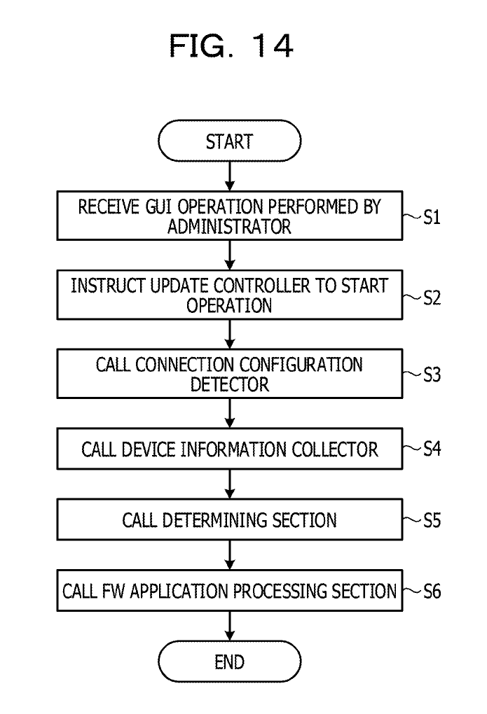

Next, the flow of the FW update process by the FW updating section 2a is described. FIG. 14 is a flowchart of the FW update process by the FW updating section 2a. As illustrated in FIG. 14, the GUI section 21 receives a GUI operation performed by the administrator and instructing the FW to be updated (S1) and instructs the update controller 22 to start the update operation (S2).

Then, the update controller 22 calls the connection configuration detector 23 (S3) and calls the device information collector 24 (S4). Then, the update controller 22 calls the determining section 25 (S5) and calls the FW application processing section 26 (S6).

Since the update controller 22 sequentially calls the connection configuration detector 23, the device information collector 24, the determining section 25, and the FW application processing section 26, the FW updating section 2a may update the FW.

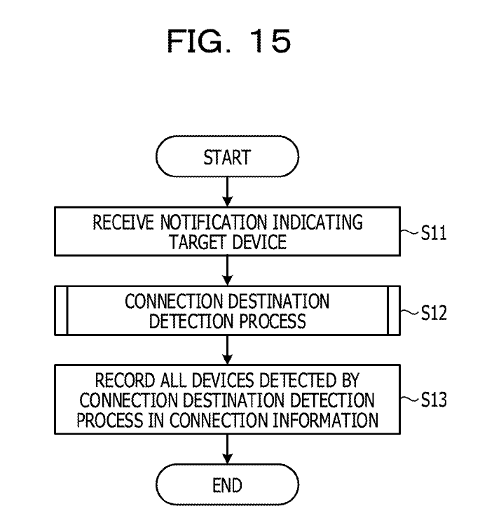

Next, the flow of a process by the connection configuration detector 23 is described. FIG. 15 is a flowchart of the process by the connection configuration detector 23. As illustrated in FIG. 15, the connection configuration detector 23 receives a notification indicating a target device from the GUI section 21 (S11).

Then, the connection configuration detector 23 executes a connection destination detection process of detecting devices coupled to the target device within the same network in the network layer (S12). Then, the connection configuration generator 34 records all the devices detected by the connection destination detection process in the connection information 3c (S13).

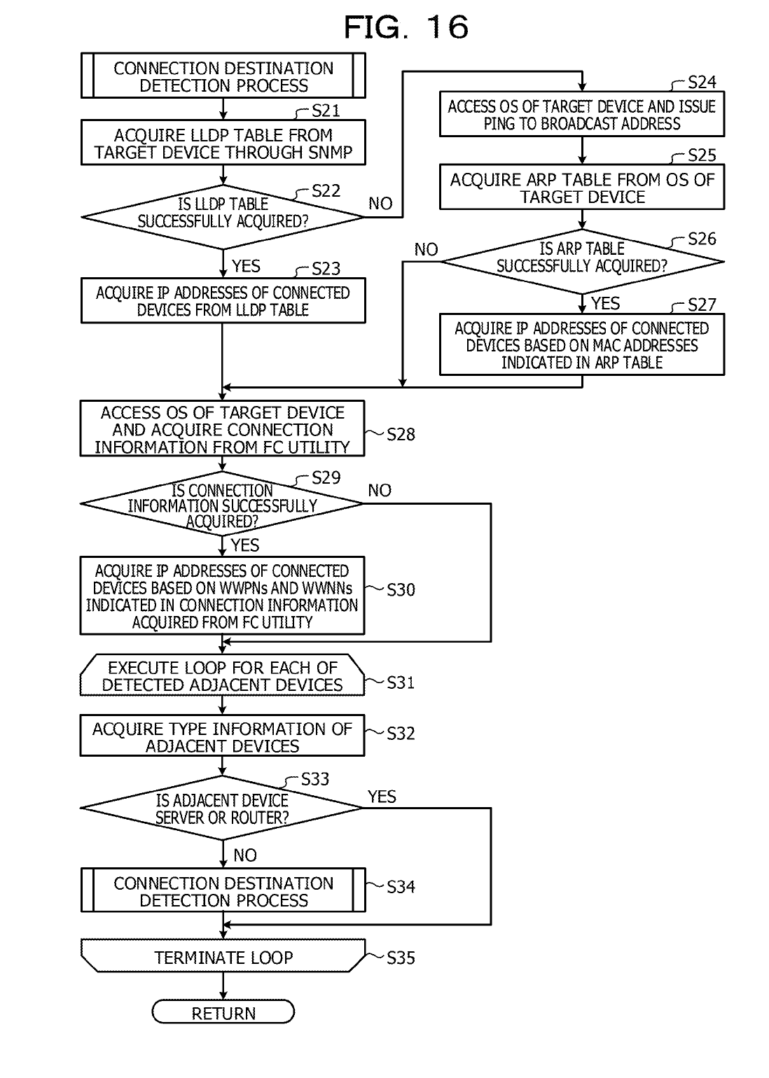

FIG. 16 is a flowchart of the connection destination detection process. As illustrated in FIG. 16, the device detector 31 acquires an LLDP table from the target device through the Simple Network Management Protocol (SNMP) (S21). Then, the device detector 31 determines whether or not the device detector 31 successfully acquired the LLDP table (S22).

If the device detector 31 successfully acquired the LLDP table, the device detector 31 acquires IP addresses of the coupled devices from the LLDP table (S23). If the device detector 31 did not successfully acquire the LLDP table, the device detector 31 accesses an OS of the target device and issues the PING to a broadcast address (S24). Then, the device detector 31 acquires an Address Resolution Protocol (ARP) table from the OS of the target device (in S25). Then, the device detector 31 determines whether or not the device detector 31 successfully acquired the ARP table (S26). If the device detector 31 successfully acquired the ARP table, the device detector 31 acquires the IP addresses of the coupled devices based on Media Access Control (MAC) addresses indicated in the ARP table (S27).

By the aforementioned processes S21 to S27, the device detector 31 detects adjacent devices coupled in the LAN. Then, by the aforementioned processes S28 to S30, the device detector 31 detects adjacent devices coupled by FCs. Specifically, the device detector 31 accesses the OS of the target device and acquires connection information from an FC utility (S28). Then, the device detector 31 determines whether or not the device detector 31 successfully acquired the connection information (S29). If the device detector 31 successfully acquired the connection information, the device detector 31 acquires the IP addresses of the coupled devices based on world wide port names (WWPNs) and world wide node names (WWNNs) indicated in the connection information acquired from the FC utility (S30).

Then, the connection configuration detector 23 executes a process between S31 and S35 for each of the detected adjacent devices. Specifically, the adjacency information acquirer 32 uses the acquired IP addresses to acquire type information of an adjacent device (S32). Then, the range terminal determining section 33 determines whether the adjacent device is a server 5 or a router 3 (S33).

If the adjacent device is not a server 5 or a router 3, the connection configuration detector 23 executes the connection destination detection process (S34). Specifically, the connection configuration detector 23 recursively calls the connection destination detection process. By recursively calling the connection destination detection process, the connection configuration detector 23 may detect the coupled devices at a low load within a short time period. If the adjacent device is a server 5 or a router 3, the connection configuration detector 23 does not trace a device coupled on the far side with respect to the adjacent device and terminates the connection destination detection process executed on the adjacent device.

When the process between S31 and S35 are completely executed on all the adjacent devices, the connection configuration detector 23 terminates the connection destination detection process and causes the connection destination detection process to return to a source from which the connection destination detection process was called.

Thus, if a coupled device is a server 5 or a router 3, the connection configuration detector 23 does not trace a device coupled on the far side with respect to the coupled device and a time for detecting the coupled devices may be reduced.

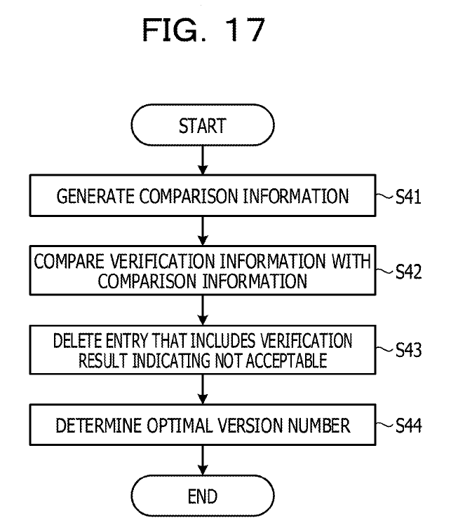

Next, the flow of a process by the determining section 25 is described. FIG. 17 is a flowchart of the process by the determining section 25. As illustrated in FIG. 17, the comparison information generator 41 generates the comparison information 3d (S41). Then, the comparing section 42 compares the verification information 7b with the comparison information 3d (S42).

Then, the deleting section 43 deletes, from the comparison information 3d, an entry that includes a verification result indicating not acceptable (S43). Then, the optimal version extractor 44 determines the optimal version based on the number of verification results indicating acceptable and the number of verification results indicating no verification information (S44) and records the determined optimal version as a determination result 3e.

Thus, since the verification information 7b is compared with the comparison information 3b and an entry that includes a verification result indicating not acceptable is deleted from the comparison information 3d, the determining section 25 may inhibit a problem from occurring due to the FW update.

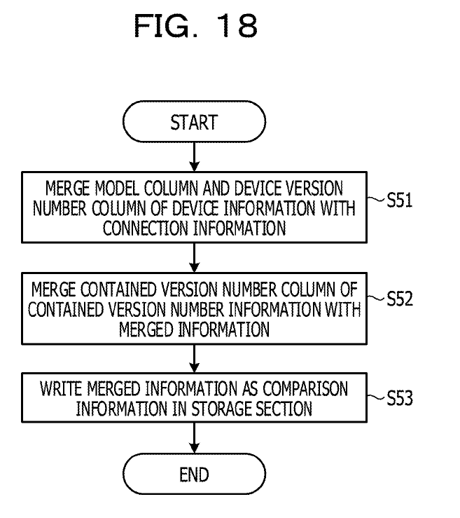

Next, the flow of a process of generating the comparison information 3d is described. FIG. 18 is a flowchart of the process of generating the comparison information 3d. The process illustrated in FIG. 18 corresponds to S41 illustrated in FIG. 17.

As illustrated in FIG. 18, the comparison information generator 41 merges a model column included in the device information 3a and a device version number column included in the device information 3a with the connection information 3c (S51). In this case, the model column is merged with both connection source device field and connection destination device field of the connection information 3a. The device version number column is merged with the connection destination device field of the connection information 3a.

Then, the comparison information generator 41 merges a contained version number column included in the contained version number information 7a with the information merged in S51 (S52). Then, the comparison information generator 41 writes the information merged in S52 as the comparison information 3d in the storage section 2b (S53).

By generating the comparison information 3d, the comparison information generator 41 may extract all combinations of version numbers between which the compatibility of the FW is to be checked.

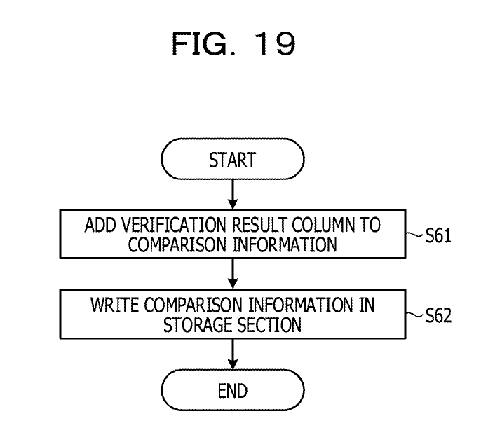

Next, the flow of a process of comparing the verification information 7b with the comparison information 3d is described. FIG. 19 is a flowchart of the process of comparing the verification information 7b with the comparison information 3d. The process illustrated in FIG. 19 corresponds to S42 illustrated in FIG. 17.

As illustrated in FIG. 19, the comparing section 42 adds a verification result column to the comparison information 3d based on the verification information 7b (S61). Then, the comparing section 42 writes, in the storage section 2b, the comparison information 3d to which the verification result column was added (S62).

Since the comparing section 42 generates the comparison information 3d to which the verification result column was added, the determining section 25 may record the results of checking the compatibility of the FW in the comparison information 3d.

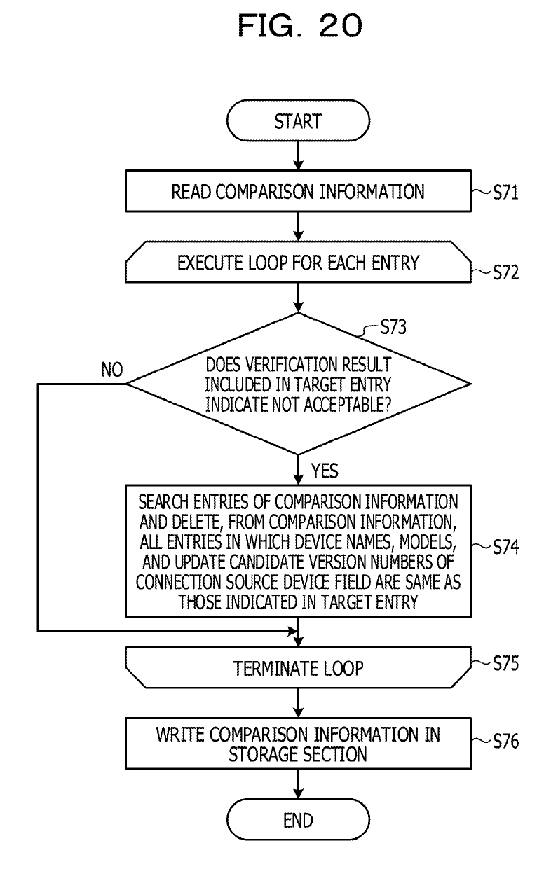

Next, the flow of a process of deleting an entry that includes a verification result indicating not acceptable is described. FIG. 20 is a flowchart of the process of deleting an entry that includes a verification result indicating not acceptable. The process illustrated in FIG. 20 corresponds to S43 illustrated in FIG. 17.

As illustrated in FIG. 20, the deleting section 43 reads the comparison information 3d (S71). Then, the deleting section 43 executes a process between S72 and S75 for each of entries of the comparison information 3d. Specifically, the deleting section 43 determines whether or not a verification result included in a target entry indicates not acceptable (S73). If the verification result included in the target entry does not indicate not acceptable, the process executed on the target entry is terminated.

If the verification result included in the target entry indicates not acceptable, the deleting section 43 searches each of the entries of the comparison information 3d. Then, the deleting section 43 deletes, from the comparison information 3d, all entries in which device names, models, and update candidate version numbers of the connection source device field are the same as those indicated in the target entry (S74).

After executing the process between S72 and S75 on all the entries of the comparison information 3d, the deleting section 43 writes the comparison information 3d in the storage section 2b (S76) and terminates the process.

Since the deleting section 43 deletes, from the comparison information 3d, all entries in which device names, models, and update candidate version numbers of the connection source device field are the same as those indicated in an entry that includes a verification result indicating not acceptable, the FW updating section 2a may inhibit a problem from occurring due to the FW update.

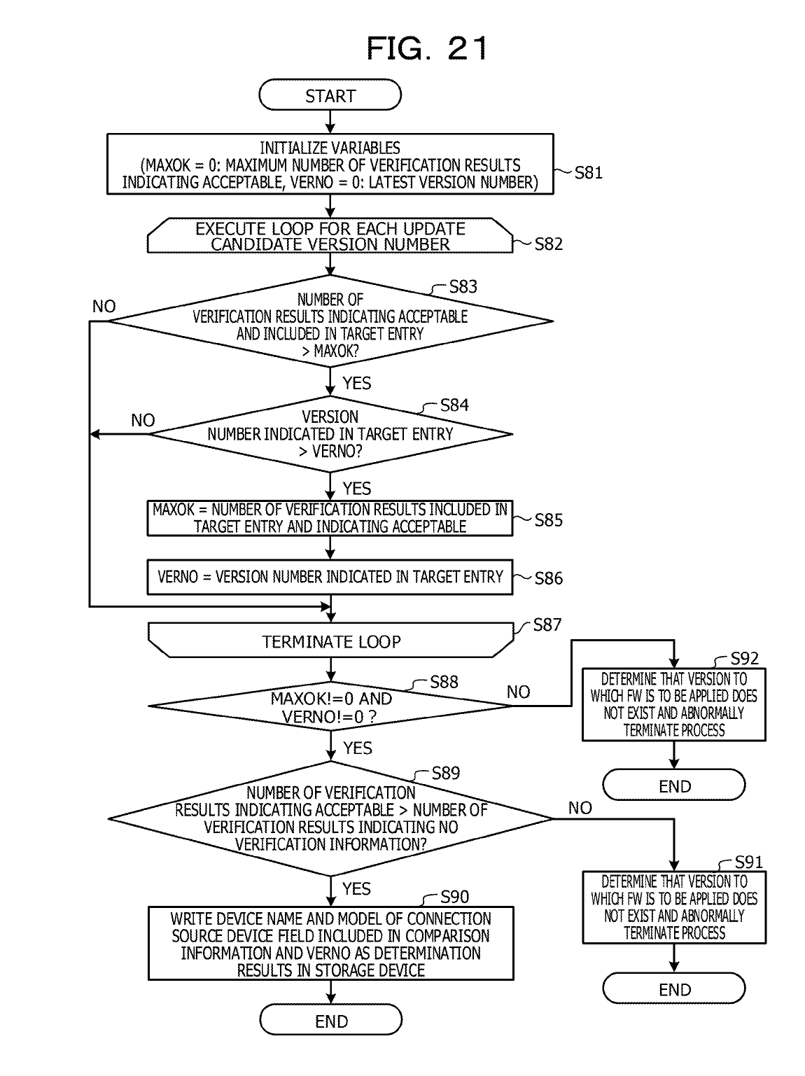

Next, the flow of a process of determining the optimal version is described. FIG. 21 is a flowchart of the process of determining the optimal version. The process illustrated in FIG. 21 corresponds to S44 illustrated in FIG. 17.

As illustrated in FIG. 21, the optimal version extractor 44 initializes variables to be used for the process (S81). Specifically, the optimal version extractor 44 sets, to 0, a value of MAXOK indicating the maximum number of verification results indicating acceptable and associated with an update candidate version and a value of VERNO indicating the latest version number among update candidate version numbers that are each associated with verification results that indicate acceptable and whose number is the largest.

Then, the optimal version extractor 44 executes a process between S82 to S87 for each of the update candidate version numbers. Specifically, the optimal version extractor 44 determines whether or not the number of verification results indicating acceptable and included in a target entry (target update candidate version number) is larger than MAXOK (S83). If the number of the verification results indicating acceptable and included in the target entry is not larger than MAXOK, the optimal version extractor 44 terminates the process executed on the target entry.

If the number of the verification results indicating acceptable and included in the target entry is larger than MAXOK, the optimal version extractor 44 determines whether or not an update candidate version number indicated in the target entry is larger than VERNO (S84). If the update candidate version number indicated in the target entry is not larger than VERNO, the optimal version extractor 44 terminates the process executed on the target entry.

If the update candidate version number indicated in the target entry is larger than VERNO, the optimal version extractor 44 sets, as the value of MAXOK, the number of the verification results indicating acceptable and included in the target entry (S85) and sets the update candidate version number indicated in the target entry as the value of VERNO (S86).

Then, when terminating the process between S82 and S87 on all the update candidate version numbers, the optimal version extractor 44 determines whether or not MAXOK is unequal to 0 and whether or not VERNO is unequal to 0 (S88). In FIG. 21, “!=” indicates “unequal”. If MAXOK is 0 or VERNO is 0, the optimal version extractor 44 determines that a version of the FW that is to be applied does not exist and the optimal version extractor 44 abnormally terminates the process (S92).

On the other hand, if MAXOK is not 0 and VERNO is not 0, the optimal version extractor 44 determines whether or not the number of verification results indicating acceptable and associated with the optimal version number indicated by the value of VERNO is larger than the number of verification results indicating no verification information (S89). If the number of the verification results indicating acceptable is not larger than the number of the verification results indicating no verification information, the optimal version extractor 44 determines that a version of the FW that is to be applied does not exist and the optimal version extractor 44 abnormally terminates the process (S91).

On the other hand, if the number of the verification results indicating acceptable is larger than the number of the verification results indicating no verification information, the optimal version extractor 44 writes, as determination results in the storage section 2b, a device name and model indicated in the connection source device field included in the comparison information 3d and VERNO (S90).

By extracting the latest version whose number is associated with verification results that indicate acceptable and whose number is the largest, the optimal version extractor 44 may select the optimal version from among the multiple update candidate versions.

As described above, in the embodiment, the connection configuration detector 23 detects devices coupled, in a predetermined range, to a target device to be subjected to the FW update. Then, the determining section 25 selects a version to which the FW is to be updated from among versions of which combinations with the FW installed in the devices detected by the connection configuration detector 23 do not have a problem. Then, the FW application processing section 26 applies, to the target device, the FW of the version selected by the determining section 25. Thus, the FW updating section 2a may reduce the number of devices to be checked in order to confirm whether or not a problem occurs and the FW updating section 2a may reduce a time for checking the devices.

In the embodiment, the connection configuration detector 23 detects, within the same network in the network layer, devices that are coupled to a target device to be subjected to the FW update. Thus, the connection configuration detector 23 may detect, in an appropriate range, devices to be checked in order to confirm whether or not a problem occurs.

In the embodiment, the determining section 25 selects, as a version to which the FW is to be updated, the latest version among update candidate version numbers that are each associated with verification results that indicate acceptable and whose number is the largest. Thus, the optimal version extractor 44 may select the optimal version from among the multiple update candidate versions.

In the embodiment, if the number of verification results that indicate acceptable and are associated with the optimal version number indicated by the value of VERNO is not larger than the number of verification results indicating no verification information, the determining section 25 determines that an appropriate version to which the FW is to be updated does not exist. Thus, the FW updating section 2a may reduce a risk of causing a problem to occur due to the FW update.

Although the embodiment describes the managing device 2, a management program that has the same functions as the managing device 2 may be obtained by achieving the configuration included in the managing device 2 by software. A computer that executes the management program is described below.

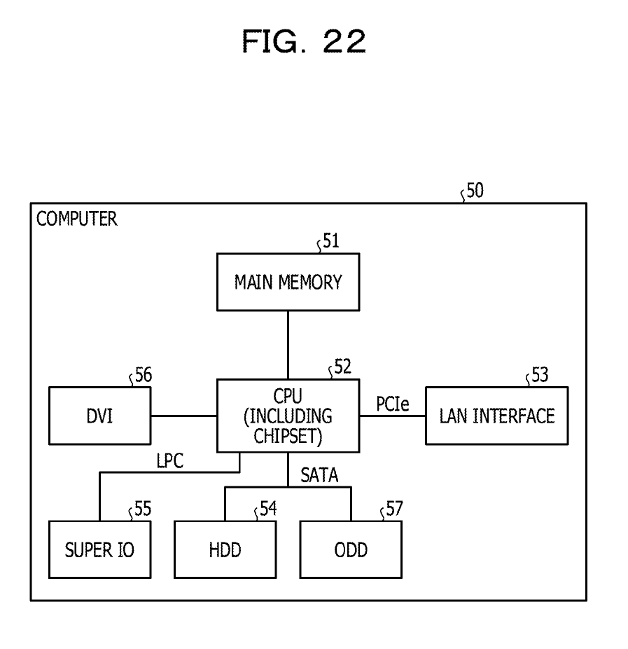

FIG. 22 is a diagram illustrating a hardware configuration of the computer that executes the management program according to the embodiment. As illustrated in FIG. 22, the computer 22 includes a main memory 51, a CPU 52, a LAN interface 53, and an HDD (hard disk drive) 54. The computer 50 includes super input output (IO) 55, a digital visual interface (DVI) 56, and an optical disc drive (ODD) 57.

The main memory 51 is a memory that stores the program, results of the progress of the execution of the program, and the like. The CPU 52 is a central processing unit that reads the program from the main memory 51 and executes the program. The CPU 52 includes a chipset including a main controller.

The LAN interface 53 is an interface that connects the computer 50 to another computer through a LAN. The HDD 54 is a disk device that stores the program and data. The super IO 55 is an interface that connects input devices such as a mouse and a keyboard to the computer 50. The DVI 56 is an interface that connects a liquid crystal display device to the computer 50. The ODD 57 is a device that reads and writes data from and in a DVD.

The LAN interface 53 is coupled to the CPU 52 by PCI express (PCIe). The HDD 54 and the ODD 57 are coupled to the CPU 52 by Serial Advanced Technology Attachment (SATA). The super IO 55 is coupled to the CPU 52 by Low Pin Count (LPC).

The management program to be executed by the computer 50 is stored in the DVD, read by the ODD 57 from the DVD, and installed in the computer 50. Alternatively, the management program may be stored in a database of another computer system coupled to the computer 50 through the LAN interface 53 or the like, read from the database, and installed in the computer 50. The installed management program is stored in the HDD 54, read into the main memory 51, and executed by the CPU 52.

The embodiment describes the case where the FW of the servers 5 is updated. The embodiment, however, is not limited to this and is applicable to a case where the FW of the other devices such as the NW switches 4 is updated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A management method executed by a processor included in an information processing device coupled to a network that includes a plurality of devices, the plurality of devices including a target device in which a control program is to be updated, the management method comprising:
extracting one or more devices from the plurality of devices by determining whether each of the plurality of devices belongs to a predetermined range within the network;
determining, for each of the extracted one or more devices, whether a combination of the extracted device with the control program after updating has a problem; and
updating the control program for the target device when it is determined that the combination does not have a problem.

2. The management method according to claim 1,
wherein the extracting includes determining that a device that is among the plurality of devices and coupled to the target device through a router does not belong to the predetermined range.

3. The management method according to claim 1, further comprising:
storing verification information including a plurality of entries in which the target device, a version of the control program of the target device, devices combined with the target device, versions of the control program of the combined devices, and results of verifying the compatibility of the combination are associated with each other,
wherein the determining includes:
determining that the combination has a problem when information that indicates that the combination has a problem is included in the verification information, and
determining that the combination does not have a problem when the information that indicates that the combination has a problem is not included in the verification information or when information that indicates that the combination does not have a problem is included in the verification information.

4. The management method according to claim 3, further comprising:
counting, based on the verification information for each of a plurality of versions of the control program, the number of devices that do not cause the combination to have a problem; and
selecting, from among the plurality of versions, a version associated with devices that do not cause the combination to have a problem and whose number is the largest as a version to which the control program is to be updated for the target device.

5. The management method according to claim 4,
wherein the selecting includes selecting a version to which the control program is to be updated when the number of devices associated with the information indicating that the combination does not have a problem is larger than the number of devices that are not associated with the information indicating that the combination has a problem.

6. The management method according to claim 4, further comprising:
generating comparison information by deleting, from the plurality of entries included in the verification information, one or more entries including verification results indicating that the compatibility of the combination has a problem,
wherein the counting includes counting, for each of the plurality of versions, the number of devices that do not cause the combination to have a problem, using the comparison information.

7. The management method according to claim 6,
wherein the one or more entries are all entries related to a version associated with the verification results indicating that the compatibility of the combination has a problem.

8. The management method according to claim 1,
wherein the predetermined range is within the same network in the network layer.

9. An information processing device coupled to a network that includes a plurality of devices including a target device in which a control program is to be updated, comprising:
a memory; and
a processor coupled to the memory and configured to:
extract one or more devices from the plurality of devices by determining whether each of the plurality of devices belongs to a predetermined range within the network;
determine, for each of the extracted one or more devices, whether a combination of the device with the control program after updating has a problem; and
update the control program for the target device when it is determined that the combination does not have a problem.

10. A non-transitory computer-readable storage medium storing a program that causes a processor included in an information processing device to execute a process, the information processing device being coupled to a network including a plurality of devices including a target device in which a control program is to be updated, the process comprising:
extracting one or more devices from the plurality of devices by determining whether each of the plurality of devices belongs to a predetermined range within the network;
determining, for each of the extracted one or more devices, whether or not a combination of the device with the control program after updating has a problem; and
updating the control program for the target device when it is determined that the combination does not have a problem.
